(19) United States
(12) Patent Application Publication
(10) Pub. No.: US 2022/0327711 A1
(43) Pub. Date: Oct. 13, 2022

(54) IMAGE SEGMENTATION METHOD AND APPARATUS, ELECTRONIC DEVICE AND STORAGE MEDIUM

(71) Applicant: SHANGHAI SENSETIME INTELLIGENT TECHNOLOGY CO., LTD., Shanghai (CN)

(72) Inventors: Guotai WANG, Shanghai (CN); Xiangde Luo, Shanghai (CN); Tao Song, Shanghai (CN)

(21) Appl. No.: 17/849,020

(22) Filed: Jun. 24, 2022

(30) Foreign Application Priority Data
Dec. 31, 2019 (CN) 201911407338.8

(51) Int. Cl. G06T 7/11; G06T 7/143; G06T 7/00; G06T 7/194

(52) U.S. Cl. CPC G06T 7/11; G06T 7/143; G06T 7/0012; G06T 7/194; G06T 2207/30096; G06T 2207/20084; G06T 2207/20081; G06T 2207/10088; G06T 2207/10081

(57) ABSTRACT

An image segmentation method and apparatus, an electronic device and a storage medium are provided. In the method, a first segmentation result of a target image is obtained, the first segmentation result representing a probability that each pixel in the target image belongs to each category before correction. At least one correction point and a category to be corrected corresponding to the at least one correction point are obtained; and a second segmentation result is obtained by correcting the first segmentation result according to the at least one correction point and said category.

### CROSS-REFERENCE TO RELATED APPLICATION

The present application is a continuation of International Patent Application No. PCT/CN2020/100706, filed on Jul. 7, 2020, which is filed based upon and claims priority to Chinese Patent Application No. 201911407338.8, filed on Dec. 31, 2019. The disclosures of International Patent Application No. PCT/CN2020/100706 and Chinese Patent Application No. 201911407338.8 are hereby incorporated by reference in their entirety.

### BACKGROUND

Medical image segmentation is to segment parts with some special meanings (e.g., organs or lesions) or extract features of relevant parts from medical images, which can provide a reliable basis for clinical diagnosis and pathological research, and help doctors make a more accurate diagnosis. The image segmentation process is to segment the image into multiple regions. There are similar properties, such as gray scales, colors, textures, luminances and contrasts, in each of these regions. In the related art, methods like feature threshold or clustering, edge detection, region growth or region extraction are often used for segmentation.

### SUMMARY

The disclosure relates to the technical field of computers, and particularly to an image segmentation method and apparatus, an electronic device and a storage medium.

The embodiments of the disclosure provide an image segmentation method, which may include that: a first segmentation result of a target image is acquired, the first segmentation result representing a probability that each pixel in the target image belongs to each class before correction; at least one correction point and a to-be-corrected class corresponding to the at least one correction point are acquired; and a second segmentation result is obtained by correcting the first segmentation result according to the at least one correction point and the to-be-corrected class.

In some embodiments, the first segmentation result includes multiple first probability images, each probability image corresponds to one class, the first probability image represents a probability that each pixel in the target image belongs to a class corresponding to the first probability image before correction, and the operation that the second segmentation result is obtained by correcting the first segmentation result corrected according to the at least one correction point and the to-be-corrected class may include that: a correction image of the to-be-corrected class is determined according to a similarity between each pixel of the target image and the correction point; a second probability image of the to-be-corrected class is obtained by correcting a first probability image of the to-be-corrected class according to the correction image of the to-be-corrected class, the second probability image of the to-be-corrected class representing a probability that each pixel in the target image belongs to the to-be-corrected class after correction; and the second segmentation result of the target image is determined according to the second probability image of the to-be-corrected class. In this way, the correction image of the to-be-corrected class that is determined according to the similarity between the pixel of the target image and the correction point may serve as a priori probability image provided by a user, thereby correcting a wrongly segmented region in the first segmentation result.

In some embodiments, the operation that the second segmentation result of the target image is determined according to the second probability image of the to-be-corrected class may include that: the second segmentation result of the target image is determined according to the second probability image of the to-be-corrected class and a first probability image of an uncorrected class, the uncorrected class representing a class in classes corresponding to the multiple probability images except for the to-be-corrected class. In this way, by determining the second segmentation result according to the second probability image of the to-be-corrected class and the first probability image of the uncorrected class, not only is the wrongly segmented region of the to-be-corrected class corrected, but the portion not wrongly segmented is also retained, thereby improving the accuracy of image segmentation.

In some embodiments, the operation that the correction image corresponding to the to-be-corrected class is determined according to the similarity between each pixel of the target image and the correction point may include that: the correction image of the to-be-corrected class is obtained by performing an exponential transformation on a geodesic distance of each pixel of the target image relative to the correction point. In this way, by using the exponential geodesic distance to encode the correction point provided by the user, the first segmentation result is corrected; and the whole correction process does not involve in the correction process of the neutral network, thereby saving the time and improving the correction efficiency.

In some embodiments, the operation that the second probability image of the to-be-corrected class is obtained by correcting the first probability image of the to-be-corrected class according to the correction image of the to-be-corrected class may include that: the second probability image of the to-be-corrected class is obtained by determining, for each pixel of the target image, a first value as a value at a position of the pixel in the second probability image of the to-be-corrected class in a case where the first value of the pixel is greater than a second value, the first value being a value at a position of the pixel in the correction image of the to-be-corrected class, and the second value being a value at a position of the pixel in the first probability image of the to-be-corrected class. In this way, by using a maximum correction policy for a local region of the target image in the correction process, the computational burden is reduced.

In some embodiments, the method may further include that: in a case where segmentation operation for a target object in an original image is received, multiple labeling points for the target object are acquired; a bounding box of the target object is determined according to the multiple labeling points; the target image is obtained by clipping the original image based on the bounding box of the target object; a first probability image of a class of background in the target image and a first probability image of a class corresponding to the target object in the target image are respectively acquired; and a first segmentation result of the target image is determined according to the first probability image of the class corresponding to the target object in the target image and the first probability image of the class of the background in the target image. In this way, by adding the labeling points for the target object, the target image including the target object may be obtained; and the first segmentation result of the target image may be obtained according to the first probability image of the target object corresponding class and the first probability image of the background class.

In some embodiments, the first probability image of the target object corresponding class and the first probability image of the background class are acquired by a convolutional neural network, and the operation that the first probability images of the class corresponding to the target object in the target image and the class of the background in the target image are respectively acquired may include that: an encoded image for the labeling points is obtained by performing an exponential transformation on a geodesic distance of each pixel of the target image relative to the labeling points; and the first probability image of the target object corresponding class and the first probability image of the background class are obtained by inputting the target image and the encoded image for the labeling points to the convolutional neural network. In this way, the target image is quickly and effectively segmented by the convolutional neural network, such that the user can obtain the good segmentation effect with less time and less interaction.

In some embodiments, the method may further include that: the convolutional neural network is trained, including: in a case where a sample image is acquired, multiple edge points are generated for a training object according to a tag pattern of the sample image, the tag pattern being configured to indicate a class to which each pixel in the sample image belongs; a bounding box of the training object is determined according to the multiple edge points; a training region is obtained by clipping the sample image based on the bounding box of the training object; an encoded image for the edge points is obtained by performing an exponential transformation a geodesic distance of each pixel of the training region relative to the edge points; a first probability image of a class corresponding to a training object in the training region and a first probability image of a class of background in the training region are obtained by inputting the training region and the encoded image for the edge points to a to-be-trained convolutional neural network; a loss value is determined according to the first probability image of the class corresponding to the training object in the training region, the first probability image of the class of the background in the training region and the tag pattern of the sample image; and parameters of the to-be-trained convolutional neural network are updated according to the loss value. In this way, with the utilization of the edge points for guiding the convolutional neural network, the stability and generalization performance of the network are improved, and the timeliness and generalization performance of the algorithm are improved; the good segmentation effect may be obtained only with a small amount of training data; and an unseen segmentation object may be processed.

In some embodiments, a region where the bounding box determined according to the multiple edge points is located covers a region where the training object in the sample image is located. In this way, the clipped training region may include context information of the edge points.

In some embodiments, the target image includes a medical image, and each class includes at least one of a background and an organ or a lesion. In this way, the organ or the lesion may be quickly and accurately segmented from the medical image.

In some embodiments, the medical image includes at least one of a Magnetic Resonance Imaging (MRI) image or a Computer Tomography (CT) image. In this way, the segmentation processing may be quickly and accurately performed on at least one of the MRI image or the CT image.

The embodiments of the disclosure provide an image segmentation apparatus, which may include: a first acquisition module, configured to acquire a first segmentation result of a target image, the first segmentation result representing a probability that each pixel in the target image belongs to each class before correction; a second acquisition module, configured to acquire at least one correction point and a to-be-corrected class corresponding to the at least one correction point; and a correction module, configured to obtain a second segmentation result by correcting the first segmentation result according to the at least one correction point and the to-be-corrected class.

The embodiments of the disclosure provide an electronic device, which may include: a processor; and a memory, configured to store an instruction executable for the processor; and the processor is configured to call the instruction stored in the memory to execute the above method.

The embodiments of the disclosure provide a computer-readable storage medium, in which a computer program instruction is stored, the computer program instruction being executed by a processor to implement the above method.

The embodiments of the disclosure provide a computer program, which may include a computer-readable code; and when the computer-readable code runs in a device, a processor in the device implements the image segmentation method executed by the processor in the above one or more embodiments.

### BRIEF DESCRIPTION OF THE DRAWINGS

FIG. 1 illustrates a flowchart of an image segmentation method according to an embodiment of the disclosure.

FIG. 2 illustrates an example of a first segmentation result according to an embodiment of the disclosure.

FIG. 3 illustrates a correction diagram according to an embodiment of the disclosure.

FIG. 4 illustrates a flowchart of an image segmentation method according to an embodiment of the disclosure.

FIG. 5A illustrates an example of a sample image.

FIG. 5B illustrates an example of an encoded image of an edge point based on an Euclidean distance.

FIG. 5C illustrates an example of an encoded image of an edge point based on a Gaussian distance.

FIG. 5D illustrates an example of an encoded image of an edge point based on a geodesic distance.

FIG. 5E illustrates an example of an encoded image of an edge point based on an exponential geodesic distance.

FIG. 6 illustrates an implementation flowchart of an image segmentation method according to an embodiment of the disclosure.

FIG. 7 illustrates a block diagram of an image segmentation apparatus according to an embodiment of the disclosure.

FIG. 8 illustrates a block diagram of an electronic device 800 according to an embodiment of the disclosure.

FIG. 9 illustrates a block diagram of an electronic device 1900 according to an embodiment of the disclosure.

### DETAILED DESCRIPTION

Various exemplary embodiments, features and aspects of the present disclosure will be described below in detail with reference to the accompanying drawings. The same reference signs in the drawings represent components with the same or similar functions. Although various aspects of the embodiments is shown in the drawings, the drawings are not necessarily to be drawn to scale, unless otherwise specified.

Herein, special term “exemplary” refers to “use as an example, embodiment or description”. Herein, any “exemplarily” described embodiment may not be explained to be superior to or better than other embodiments.

The term “and/or” herein is only an association relationship for describing associated objects, and represents that three relationships may exist, for example, a and/or b may represent that: a exists alone, a and a exist at the same time, and b exists alone. In addition, the term “at least one type” herein represents any one of multiple types or any combination of at least two types in the multiple types, for example, at least one type of a, b and c may represent any one or multiple elements selected from a set formed by the a, the b and the c.

In addition, for describing the disclosure better, many specific details are presented in the following specific implementation modes. It is to be understood by those skilled in the art that the disclosure may still be implemented even without some specific details. In some examples, methods, means, components and circuits known very well to those skilled in the art are not described in detail, to highlight the subject of the present disclosure.

With radiotherapy as an example, the medical image segmentation is to: (1) research the anatomical structure; (2) recognize a region where the target object is located (i.e., localize a tumor, a lesion and another abnormal tissue); (3) measure the volume of the target object; (4) observe the decrease of the target object in volume during growth or treatment of the target object, so as to provide a help for planning before treatment and for the treatment; and (5) compute the radiation dose. The image segmentation in the related art may be divided into three classes: (1) manual sketch; (2) semi-automatic segmentation (interactive segmentation); and (3) full-automatic segmentation. The manual sketch is an expensive and time-consuming process because the medical image is generally low in imaging quality and the border of the organ or lesion is vague, particularly, the medical image needs to be segmented by a doctor with the professional background. Hence, it is hard for the manual sketch to process a large number of various images that are produced quickly. The semi-automatic segmentation refers to that the user first specifies a part of foreground and a part of background in the image with an interactive method, and then the input of the user in the algorithm is used as a constraint condition for segmentation to automatically compute the segmentation meeting the constraint condition. The semi-automatic segmentation refers to that the user is allowed to iteratively correct the segmentation result unceasingly till the segmentation result is accepted. The full-automatic segmentation is to segment, with the algorithm, the region where the target object in the input image is located. The full-automatic or semi-automatic segmentation algorithms in the related art may mostly be divided into the following four classes: feature threshold or clustering, edge detection, region growth or region extraction. Besides, the deep learning algorithm, such as the convolutional neutral network, is used for image segmentation with good effect in the related art. However, the deep learning algorithm is a data-driven algorithm and the segmentation effect are susceptible to the quantity and quality of labeled data; and moreover, the robustness and accuracy of the deep learning algorithm are not verified well. For the specific application field such as medical field, the data collection and labeling are expensive and time-consuming, and the segmentation result is also difficult to be directly applied to clinical practice.

Thus, the image segmentation in the related art has the following problems: (1) the amount of information extracted in a manner of encoding interactive information (dots, lines, frames and the like) is insufficient; (2) the timeliness of the algorithm is not enough and the time that needs to be waited after interaction is too long; and (3) the algorithm has insufficient generalization and is not applied to processing targets not occurring in the training set.

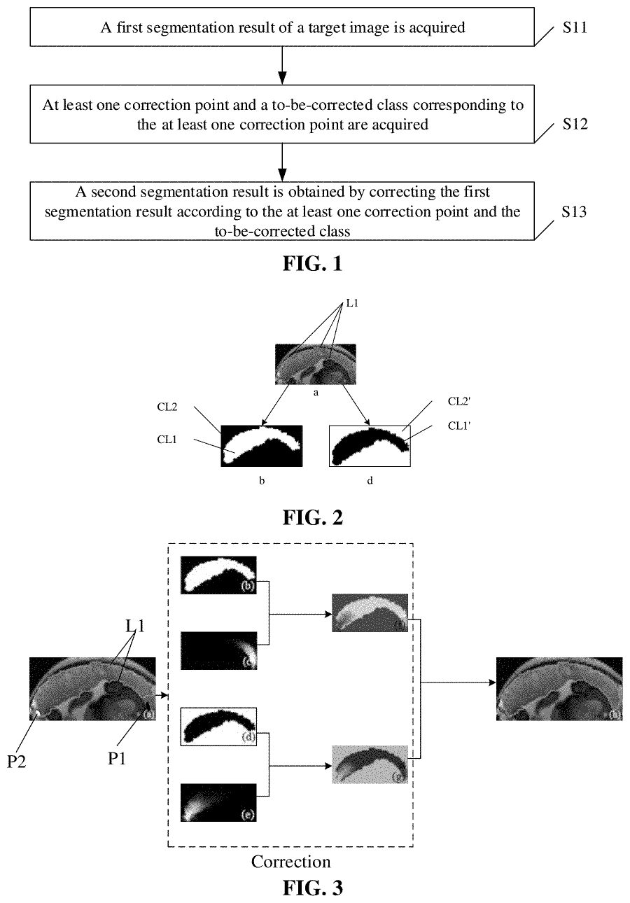

FIG. 1 illustrates a flowchart of an image segmentation method according to an embodiment of the disclosure. As shown in FIG. 1, the method may include the following steps.

In S11, a first segmentation result of a target image is acquired.

The first segmentation result represents a probability that each pixel in the target image belongs to each class before correction.

In S12, at least one correction point and a to-be-corrected class corresponding to the at least one correction point are acquired.

In S13, a second segmentation result is obtained by correcting the first segmentation result according to the at least one correction point and the to-be-corrected class.

In the embodiment of the disclosure, the correction point provided by the user may serve as priori knowledge to correct the wrongly segmented region in the initial segmentation result, thereby obtaining the corrected segmentation result; and with less user interaction, the effective and simple processing on the wrongly segmented region is implemented, and the timeliness and accuracy of image segmentation are improved.

In some embodiments, the image segmentation method may be executed by an electronic device such as a terminal device or a server. The terminal device may be User Equipment (UE), a mobile device, a user terminal, a terminal, a cell phone, a cordless phone, a Personal Digital Assistant (PDA), a handheld device, a computing device, a vehicle device, a wearable device and the like. The method may be implemented in a manner that the processor calls the computer-readable instruction stored in the memory. Or, the method may be executed by the server.

In step S11, the target image may represent a to-be-segmented image. The target image may be an image clipped from an image input by the user, and may also be the image input by the user. The target image may be a two-dimensional image, and may also be a three-dimensional image. There are no limits made on the target image in the embodiment of the disclosure. The target image may include multiple classes of target objects.

In some embodiments, the target image may include a medical image (such as an MRI image and/or a CT image), and the target object may include an organ such as a lung, a heart and a stomach or a lesion in the organ. The medical image has the features that the contrast is low, the imaging and segmentation protocols are not unified and the difference among patients is large, etc. In the medical image, the multiple classes of the target objects may include a background and an organ and/a lesion. In an example, the classes of the target objects in the target image may include the background and one or more of organs such as the stomach, the liver and the lung. In another example, the classes of the target objects in the target image may include the background and one or more of lesions in organs such as the stomach, the liver and the lung. In still another example, the classes of the target objects in the target image may include the background and lesions in the stomach and liver.

The segmentation on the target image is to segment pixel regions belonging to different classes in the target image. For example, the foreground region (such as the region where the organ such as the stomach are located, or the region where the lesion in the stomach is located) is segmented from the background region. Also for example, the region where the stomach is located and the region where the liver is located are segmented from the background region; or, the region where the brain stem is located, the region where the cerebellum is located and the region where the brain is located are segmented from the background region.

The segmentation result of the target image may be used to recognize the class to which each pixel in the target image belongs, and the probability of the class. The segmentation result of the target image may include multiple probability images. Each probability image corresponds to one class. The probability image of any class may represent a probability that each pixel in the target image belongs to the class.

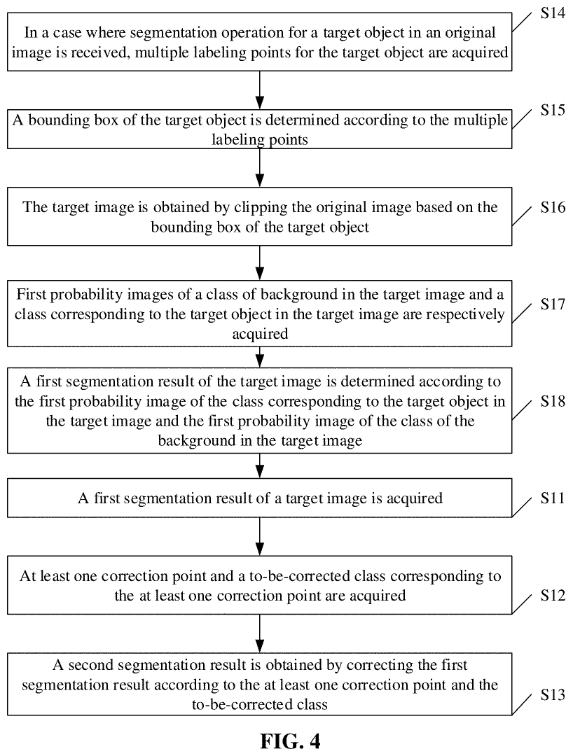

The first segmentation result may represent an initial segmentation result before correction, i.e., the first segmentation result represents a probability that each pixel in the target image belongs to each class before correction. The first segmentation result may be any segmentation result of the target image. The first segmentation result may be a segmentation result obtained with an image segmentation method in the related art, may also be a segmentation result obtained with an image segmentation method provided by FIG. 4 in the embodiment of the disclosure, and may further be a segmentation result corrected in subsequent step S15 in the embodiment of the disclosure (i.e., the second segmentation result). There are no limits made on the manner and approach for acquiring the first segmentation result in the embodiment of the disclosure.

In some embodiments, the first segmentation result includes multiple first probability images, each first probability image corresponds to one class, and the first segmentation result represents a probability that each pixel in the target image belongs to a first probability corresponding class before correction.

In the embodiment of the disclosure, the first segmentation result represents the initial segmentation result before correction; and correspondingly, the first probability image of any class may represent a probability that each pixel in the target image belongs to the class before correction. In some embodiments, the first probability image may be a binary image, i.e., the value of each pixel corresponding position in the probability image of any class may be either 0 or 1. With the probability image of A class as an example, when the value of some position in the probability image of the A class is 1, it is indicated that the probability that the pixel corresponding to the position in the target image belongs to the A class is 100%; and when the value of some position in the probability image of the A class is 0, it is indicated that the probability that the pixel corresponding to the position in the target image belongs to the A class is 0. In this case, based on the first probability image of any class, the pixel region belonging to the class and the pixel region not belonging to the class in the target image may be segmented. For example, based on the first probability image of the A class, the pixel region belonging to the A class and the pixel region not belonging to the A class in the target image may be segmented. In an example, each pixel in the pixel region corresponding to the position region, of which the value is 1 (i.e., the probability is 100%), in the probability image of the A class in the target image belongs to the A class, and each pixel in the pixel region corresponding to the position region, of which the value is 0 (i.e., the probability is 0), in the probability image of the A class in the target image does not belong to the A class.

FIG. 2 illustrates an example of a first segmentation result according to an embodiment of the disclosure. As shown in FIG. 2, the first segmentation result in the target image (a) includes two first probability images that the first probability image (b) of the foreground class and the first probability image (d) of the background class respectively. In the first probability image of the foreground class, the value of each pixel in the pixel region corresponding to the pixel region belonging to the foreground region in the target image is 1 (i.e., the value of each pixel in the region indicated by CL1 in FIG. 2 is 1), and the value of each pixel in the pixel region corresponding to the pixel region not belonging to the foreground region (i.e., belonging to the background class) in the target image is 0 (i.e., the value of each pixel in the region indicated by CL2 in FIG. 2 is 0). In the first probability image of the background class, the value of each pixel in the pixel region corresponding to the pixel region belonging to the background region in the target image is 1 (i.e., the value of each pixel in the region indicated by CL2′ in FIG. 2 is 1), and the value of each pixel in the pixel region corresponding to the pixel region not belonging to the background region (i.e., belonging to the foreground class) in the target image is 0 (i.e., the value of each pixel in the region indicated by CL1′ in FIG. 2 is 0).

In some embodiments, the first segmentation result of the target image is displayed visually. In an example, the pixel region of each class in the target image may be labeled according to the first segmentation result, for example, pixel regions of different classes may be segmented by closed labeling lines. As shown in FIG. 2, the pixel region belonging to the foreground class and the pixel region belonging to the background class in the target image may be segmented by one closed labeling line (L1). In case of three or more classes, the classes may further be distinguished by different colors of labeling lines. In the embodiment of the disclosure, the first segmentation result of the target image may further be displayed visually in other manners, and there are no limits made thereto in the disclosure.

By displaying the first segmentation result of the target image visually, the first segmentation result may be corrected by the user conveniently.

In step S12, the user may execute the correction operation when finding the wrongly segmented region in the first segmentation result. The user may first determine the correct class (i.e., the to-be-corrected class) of the wrongly segmented region. Then, the user adds the correction point of the to-be-corrected class on the target image. In this way, in a case where the correction operation for the first segmentation result is received, at least one correction point and a to-be-corrected class corresponding to the at least one correction point may be acquired.

In the embodiment of the disclosure, there may be one or more to-be-corrected classes, and the user may add one or more correction points for each to-be-corrected class. For example, the first segmentation result includes two first probability images, and the classes corresponding to the two first probability images are the foreground class and the background class respectively. When finding that a part of pixel regions belonging to the foreground class are wrongly segmented to the background class in the first segmentation result, the user may determine the foreground class as the to-be-corrected class, and add one or more correction points for the foreground class on the target image, thereby correcting the wrongly segmented regions. When finding that a part of pixel regions belonging to the foreground class are wrongly segmented to the background class in the first segmentation result, and a part of pixel regions belonging to the background class are wrongly segmented to the foreground class, the user may determine the foreground class and the background class as the to-be-corrected classes, and add one or more correction points for the foreground class and one or more correction points for the background class on the target image, thereby correcting the wrongly segmented regions. FIG. 3 illustrates a correction diagram according to an embodiment of the disclosure. As shown in FIG. 3, the user respectively adds the correction point (P1, black region) for the foreground class and the correction point (P2, white region) for the background class on the target image (a).

It is to be noted that the correction points of different correction classes may be distinguished by different colors. One correction point represents one pixel region rather than one pixel. In an example, the correction point may be a round pixel region, may also be a rectangular pixel region, and may further be a pixel region combined by at least one of the round pixel region or the rectangular pixel region. There are no limits made on the shape of the correction point in the embodiment of the disclosure.

In step S13, the second segmentation result may be obtained by correcting the first segmentation result according to the acquired correction point and the to-be-corrected class corresponding to the correction point.

The second segmentation result may represent the corrected segmentation result. The second segmentation result may be determined according to multiple second probability images. Each second probability image corresponds to one first probability image. The second probability image of any class may represent a probability that each pixel in the target image belongs to the class after correction.

In some embodiments, step S13 may include that: a correction image of the to-be-corrected class is determined according to a similarity between each pixel of the target image and the correction point; a second probability image of the to-be-corrected class is obtained by correcting a first probability image of the to-be-corrected class according to the correction image of the to-be-corrected class; and the second segmentation result of the target image is determined according to the second probability image of the to-be-corrected class. The second probability image of the to-be-corrected class represents a probability that each pixel in the target image belongs to the to-be-corrected class after correction.

For each to-be-corrected class, the correction image of the to-be-corrected class may be determined according to the similarity between each pixel of the target image and the correction point of the to-be-corrected class. In the embodiment of the disclosure, the correction point is provided by the user, and the to-be-corrected class corresponding to the correction point is the correct class of the pixel region corresponding to the correction point. Therefore, the correction point may serve as a reference to classify each pixel in the target image. In case of a large similarity between one pixel of the target image and the correction point, it is indicated that the probability that the pixel and the correction point belong to the same class is large. In case of a small similarity between one pixel of the target image and the correction point, it is indicated that the probability that the pixel and the correction point belong to the same class is small. Therefore, the correction image of the to-be-corrected class that is determined according to the similarity between the pixel of the target image and the correction point may serve as a priori probability image provided by the user, thereby correcting the wrongly segmented region in the first segmentation result.

In some embodiments, the operation that the correction image of the to-be-corrected class is determined according to the similarity between each pixel of the target image and the correction point may include that: the correction image of the to-be-corrected class is obtained by performing an exponential transformation on a geodesic distance of each pixel of the target image relative to the correction point.

The geodesic distance may well distinguish adjacent pixels of different classes, thereby improving the tag consistency of homogeneous regions. The exponential transformation may properly limit an effective region of code mapping to highlight the target object. In the embodiment of the disclosure, by performing the exponential transformation on the geodesic distance of each pixel of the target image relative to the correction point, the exponential geodesic distance of each pixel of the target image may be obtained. The correction image of the to-be-corrected class corresponding to the correction point may be obtained from exponential geodesic distances of all pixels of the target image. The value of each exponential geodesic distance belongs to [0, 1], so as to facilitate subsequent fusion between the correction image and the first probability image.

In the embodiment of the disclosure, the method for determining the geodesic distance in the related art may be used to compute the geodesic distance of each pixel of the target image relative to the correction point. In an example, the geodesic distance of each pixel of the target image relative to the correction point may be computed through a formula (1).

$${D}_{geo ( i , j , I )} = {min}_{p ( n ) ∈ {P}_{i , j}} {\int }_{0}^{1} ‖ ∇ I ( p ( n ) ) \cdot v ( n ) ‖ dn . \qquad ( 1 )$$

Where, the I represents the target image, the i represents the pixel in the target image, the j represents the pixel in reference points, the D_{geo(i,j,I)} represents the geodesic distance of the pixel i in the target image I relative to the pixel j in the correction point, the P_{i,j} represents a set of all paths between the pixel i and the pixel j, the P(n) P represents any path in P_{i,j} the ∇ I(p(n)) represents a gradient of the target image I in the P(n) direction, the ν(n) represents a unit vector tangent to the path P(n) the ∫ . . . dn represents integral operation, and the min represents the use of a minimum value for operation.

After the geodesic distance of each pixel of the target image relative to the correction point is obtained, the exponential transformation may be performed on the geodesic distance through a formula (2).

$$Edg ( i , j , I ) = {e}^{- {min}_{j ∈ {S}_{S}} {D}_{geo ( i , j , I )}} \qquad ( 2 )$$

Where, the meanings of the i, j, I, D_{geo(i,j,I)} and min may refer to the formula (1) and are not elaborated herein, the S_{S} represents a set of pixels in the target image that) belong to the reference points, the e represents a natural constant, and the Edg (i, j, I represents the exponential geodesic distance.

As shown in FIG. 3, by performing the exponential transformation on the geodesic distance of each pixel of the target image (a) relative to the correction point (P1) of the foreground class, the correction image (c) of the foreground class may be obtained; and by performing the exponential transformation on the geodesic distance of each pixel of the target image relative to the correction point (P2) of the background class, the correction image (e) of the background class may be obtained.

In the related art, the Euclidean distance, Gaussian distance, geodesic distance and the like are used to encode the correction point provided by the user, such that in a case where the segmentation result is corrected, the neutral network needs to be trained, which causes long time and low correction efficiency. Meanwhile, due to the limitation in generalization of the neutral network, the ability of processing the unseen class is poor. In the embodiment of the disclosure, by using the exponential geodesic distance to encode the correction point provided by the user, the first segmentation result is corrected; and the whole correction process does not involve in the correction process of the neutral network, thereby saving the time and improving the correction efficiency.

For any to-be-corrected class, the second probability image of the to-be-corrected class may be obtained by correcting the first probability image of the corrected class according to the correction image of the to-be-corrected class.

In the embodiment of the disclosure, the correction image and first probability image of the to-be-corrected class represent the probability that each pixel in the target image belongs to the to-be-corrected class. With a view to that the correction image of the to-be-corrected class is the priori probability image provided by the user, the probability in the correction image may be used to correct the probability in the first probability image of the same class.

In some embodiments, the operation that the second probability image of the to-be-corrected class is obtained by correcting the first probability image of the to-be-corrected class according to the correction image of the to-be-corrected class may include that: the second probability image of the to-be-corrected class is obtained by determining, for each pixel of the target image, a first value as a value at a position of the pixel in the second probability image of the to-be-corrected class, in a case where the first value of the pixel is greater than a second value, the first value being a value at a position of the pixel in the correction image of the to-be-corrected class, and the second value being a value at a position of the pixel in the first probability image of the to-be-corrected class.

For any pixel in the target image, the value of the pixel corresponding position in the correction image of the to-be-corrected class is determined as the first value of the pixel, and the value of the pixel corresponding position in the first probability image of the to-be-corrected class is determined as the second value of the pixel. Thus, the first value of the pixel may represent a priori probability that the pixel provided by the user belongs to the to-be-corrected class, and the second value of the pixel may represent an initial probability that the pixel belongs to the to-be-corrected class. When the first value of the pixel is greater than the second value of the pixel, it is indicated that the class of the pixel may be wrong, and the probability that the pixel belongs to the to-be-corrected class may be corrected. When the first value of the pixel is smaller than or equal to the second value of the pixel, it is indicated that the class of the pixel is right and is unnecessarily corrected.

As shown in FIG. 3, the first probability image (b) of the foreground class may be corrected according to the correction image (c) of the foreground class to obtain the second probability image (f) of the foreground class; and the first probability image (d) of the background class may be corrected according to the correction image (e) of the background class to obtain the second probability image (g) of the background class. In an example, the second probability image of the foreground class and the second probability image of the background class may be obtained through a formula (3).

$$\{ \begin{matrix}{F}_{f} = {max}_{i ∈ I} \{ {E}_{f} , {P}_{f} \} \\ {F}_{b} = {max}_{i ∈ I} \{ {E}_{b} , {P}_{b} \}\end{matrix} . \qquad ( 3 )$$

Referring to the formula (3), for the foreground class, the maximum value in the first value (i.e., the value of the position corresponding to the pixel i in the correction image E_{ƒ} of the foreground class) and the second value (i.e., the value of the position corresponding to the pixel i in the first probability image P_{ƒ} of the foreground class) of the pixel i in the target image I is used as the value of the pixel i corresponding position in the second probability image to obtain the second probability image F_{ƒ} of the foreground class. For the background class, the maximum value in the first value (i.e., the value of the position corresponding to the pixel i in the correction image E_{b} of the background class) and the second value (i.e., the value of the position corresponding to the pixel i in the first probability image F_{b} of the background class) of the pixel i in the target image is used as the value of the pixel i corresponding position in the second probability image to obtain the second probability image F_{b} of the background class.

In the embodiment of the disclosure, by using a maximum correction policy for a local region of the target image in the correction process, the computational burden is reduced. In the related art, in case of the correction with the manner of training the neutral network, as the network has uncertainty, it is possible that the range affected by the correction operation is large to interfere the classification result of the pixel with the correct classification.

In some embodiments, the operation that the second segmentation result of the target image is determined according to the second probability image of the to-be-corrected class may include that: the second segmentation result of the target image is determined according to the second probability image of the to-be-corrected class and a first probability image of an uncorrected class, the uncorrected class representing a class in classes corresponding to the multiple probability images except for the to-be-corrected class.

In an example, the first segmentation result includes the first probability image of the foreground class and the first probability image of the background class. In a case where the correction point of the foreground class is received, the foreground class may be determined as the to-be-corrected class and the background class may be determined as the uncorrected class. In step S13 and step S14, the correction image of the foreground class may be determined according to the similarity between each pixel of the target image and the correction point of the foreground class, and then the first probability image of the foreground class is corrected according to the correction image of the foreground class to obtain the second probability image of the foreground class. In step S15, the second segmentation result of the target image may be determined according to the second probability image of the foreground class and the first probability image of the background class.

On the basis of the formula (3), in a case where the foreground class is the to-be-corrected class, and the background class is the uncorrected class, the second probability image of the foreground class and the second probability image of the background class may be obtained through a formula (4).

$$\{ \begin{matrix}{F}_{f} = {max}_{i ∈ I} \{ {E}_{f} , {P}_{f} \} \\ {F}_{b} = {P}_{b}\end{matrix} . \qquad ( 4 )$$

On the basis of the formula (4), in a case where the foreground class is the uncorrected class, and the background class is the to-be-corrected class, the second probability image of the foreground class and the second probability image of the background class may be obtained through a formula (5).

$$\{ \begin{matrix}{F}_{f} = {P}_{f} \\ {F}_{b} = {max}_{i ∈ I} \{ {E}_{b} , {P}_{b} \}\end{matrix} . \qquad ( 5 )$$

In some embodiments, the operation that the second segmentation result of the target image is determined according to the second probability image of the to-be-corrected class may include that: the second segmentation result of the target image is determined according to the second probability image of the to-be-corrected class in the absence of the uncorrected class.

In an example, the first segmentation result corresponds to the foreground class and the background class. In a case where the correction point of the foreground class and the correction point of the background class are received, both the foreground class and the background class may be determined as the uncorrected classes. In step S13 and step S14, the correction image of the foreground class may be determined according to the similarity between each pixel of the target image and the correction point of the foreground class, the correction image of the background class may be determined according to the similarity between each pixel of the target image and the correction point of the background class, and then the first probability image of the foreground class and the first probability image of the background class may be respectively corrected according to the correction image of the foreground class and the correction image of the background class to obtain the second probability image of the foreground class and the probability image of the background class. In step S15, the second segmentation result of the target image may be determined according to the second probability image of the foreground class and the second probability image of the background class.

In some embodiments, a formula (6) may be used for normalization processing.

R_{ƒ},R_{b}=softmax(F_{ƒ},F_{b}) (6).

By introducing softmax, it is ensured that a sum of R_{ƒ} and R_{b} is 1. After that, the R_{ƒ} and the R_{b} may be integrated to a conditional random field; and by solving in a max-flow min-cut manner, the second segmentation result of the target image is obtained. The manner for solving the conditional random field may use the solving manner in the related art, and is not elaborated herein. As shown in FIG. 3, the second probability (f) image of the foreground class and the second probability image (g) of the background class are normalized and integrated to one conditional random field; and by solving in the max-flow min-cut manner, the second segmentation result of the target image, i.e., the final image (h), is obtained.

FIG. 4 illustrates a flowchart of an image segmentation method according to an embodiment of the disclosure. As shown in FIG. 4, the method may further include the following steps.

In S14, in a case where segmentation operation for a target object in an original image is received, multiple labeling points for the target object are acquired.

In S15, a bounding box of the target object is determined according to the multiple labeling points.

In S16, the original image is clipped based on the bounding box of the target object to obtain the target image.

In S17, a first probability image of a class of background in the target image and a first probability image of a class corresponding to the target object in the target image are respectively acquired.

In S18, a first segmentation result of the target image is determined according to the first probability image of the class corresponding to the target object in the target image and the first probability image of the class of the background in the target image.

In the embodiment of the disclosure, by adding the labeling points for the target object, the target image including the target object may be obtained; and the first segmentation result of the target image may be obtained according to the first probability image of the target object corresponding class and the first probability image of the background class.

In step S14, the original image may represent an image input by the user. The original image may include a medical image. The segmentation operation may represent operation of image segmentation on the original image. In the embodiment of the disclosure, the user may execute the segmentation operation by adding the labeling points in the original image. In an example, the user may first determine the class of the target object, and then add the labeling points for the class in the original image. In the embodiment of the disclosure, the multiple labeling points added by the user may be located nearby the outline of the target object; and the bounding box determined by the multiple labeling points should cover the region where the target object is located, so as to determine the bounding box in step S15. For example, three or four labeling points may be added for the target object in the two-dimensional original image; and five or six labeling points may be added for the target object in the three-dimensional original image.

In step S16, the original image may be clipped based on the bounding box of the target object to obtain the to-be-segmented target image. By clipping the target image, the region where the target object is located may be highlighted, and thus the interference of other regions on the target object may be reduced.

In step S17, the first probability images of the target object and a background class in the target image may be respectively acquired. After the user adds the labeling points for the target object, the pixels in the target image are separated into pixels belonging to the target object corresponding class and pixels not belonging to the target object corresponding class (i.e., belonging to the background class). Therefore, the first probability image of the class corresponding to the target object and the first probability image of the class of the background may be respectively acquired.

In step S18, the first segmentation result of the target image may be determined according to the first probability image of the class corresponding to the target object in the target image and the first probability image of the class of the background in the target image. In this way, the first segmentation result includes the target object corresponding class and the background class, and the first probability image of the target object corresponding class and the first probability image of the background class.

In the embodiment of the disclosure, in order to acquire the first probability image of the target object corresponding class and the first probability image of the background class, a convolutional neutral network may be trained; and the trained convolutional neutral network is used to acquire the first probability image of the target object corresponding class and the first probability image of the background class.

In some embodiments, the operation that the first probability images of the class corresponding to the target object in the target image and the class of the background in the target image are respectively acquired may include that: an exponential transformation is performed on a geodesic distance of each pixel of the target image relative to the labeling points to obtain an encoded image for the labeling points; and the target image and the encoded images for the labeling points are input to the convolutional neural network to obtain the first probability image of the target object corresponding class and the first probability image of the background class.

The convolutional neural network may be any convolutional neural network capable of extracting the probability image of each class, and there are no limits made on the structure of the convolutional neural network in the embodiment of the disclosure. The encoded image for the labeling points and the target image are input for two channels of the convolutional neural network. The output of the convolutional neural network is the probability image of each class, and is the probability image of the target object corresponding class corresponding to the labeling points and the probability image of the background class.

In the embodiment of the disclosure, the target image may be quickly and effectively segmented by the convolutional neural network, such that the user can obtain the same segmentation effect as the related art with less time and less interaction.

In some embodiments, the operation that the convolutional neural network is trained may include that: in a case where a sample image is acquired, multiple edge points are generated for a training object according to a tag pattern of the sample image, the tag pattern being configured to indicate a class to which each pixel in the sample image belongs; a bounding box of the training object is determined according to the multiple edge points; the sample image is clipped based on the bounding box of the training object to obtain a training region; an exponential transformation is performed on a geodesic distance of each pixel of the training region relative to the edge points to obtain an encoded image for the edge points; the training region and the encoded image for the edge points are input to a to-be-trained convolutional neural network to obtain a first probability image of a class corresponding to a training object in the training region and a first probability image of a class of background in the training region; a loss value is determined according to the first probability image of the class corresponding to the training object in the training region, the first probability image of the class of the background in the training region and the tag pattern of the sample image; and parameters of the to-be-trained convolutional neural network are updated according to the loss value.

The tag pattern of the sample image may be used to indicate the class to which each pixel in the sample image belongs. In an example, the pixel belonging to the corresponding class of the training object (such as the lung) in the sample image corresponds to 1 in the tag pattern, and the pixel not belonging to the corresponding class of the training object (such as belonging to the background class) in the sample image corresponds to 0 in the tag pattern. In this way, the position of the outline of the training object in the sample image may be obtained according to the tag pattern (i.e., the intersection between 0 and 1 in the tag pattern).

In the embodiment of the disclosure, multiple edge points may be generated for the training object according to the tag pattern of the sample image. The method in the related art may be used to generate the edge points in the embodiment of the disclosure; and there are no limits made on the method for generating the edge points in the embodiment of the disclosure. However, the generated edge points need to be located nearby the outline of the training object; and the region where the bounding box determined according to these edge points covers the region where the training object in the sample image is located.

In an example, three or four edge points for determining the bounding box may be generated for the training object in the two-dimensional sample image, and five or six edge points for determining the bounding box may be generated for the training object in the three-dimensional sample image. In an example, except for the edge points for determining the bounding box, n (the n may be a random number from 0 to 5) edge points may further be randomly extracted according to the tag pattern to provide more shape information. The edge points may be spread with three pixels as a radius for the fear that all edge points are located on one side of the outline; and thus, each edge point is a pixel region rather than a pixel. In order that the clipped training region includes context information, the bounding box may be stretched with several pixels, such that the region where the bounding box determined according to these edge points is located covers the region where the training object in the sample image is located and is greater than the region where the training object in the sample image is located.

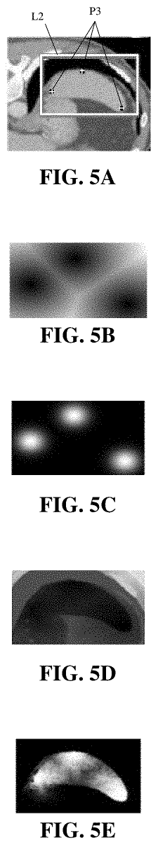

After the training region is clipped from the sample image based on the bounding box of the training object, the exponential transformation may be performed on the geodesic distance of each pixel of the training region relative to the edge points to obtain the encoded image for the edge points. FIG. 5A illustrates an example of a sample image. As shown in FIG. 5A, after the bounding box (L2) is determined according to the edge points (P3), the training region where the training object is located may be clipped from the sample image according to the bounding box (L2). FIG. 5B illustrates an example of an encoded image of an edge point based on an Euclidean distance. The encoded image shown in FIG. 5B is determined according to an Euclidean distance of each pixel of the training region shown in FIG. 5A relative to the edge points (P3). FIG. 5C illustrates an example of an encoded image of an edge point based on a Gaussian distance. The encoded image shown in FIG. 5C is determined according to a Gaussian distance of each pixel of the training region shown in FIG. 5A relative to the edge points (P3). FIG. 5D illustrates an example of an encoded image of an edge point based on a geodesic distance. The encoded image shown in FIG. 5D is determined according to a geodesic distance of each pixel of the training region shown in FIG. 5A relative to the edge points (P3). FIG. 5E illustrates an example of an encoded image of an edge point based on an exponential geodesic distance. The encoded image shown in FIG. 5E is determined according to an exponential geodesic distance of each pixel of the training region shown in FIG. 5A relative to the edge points (P3). With comparisons on the encoded images shown in FIG. 5B, FIG. 5C, FIG. 5D and FIG. 5E, the exponential geodesic distance can highlight the training object. Then, the training region and the encoded image for the edge points may be used as input for two channels of the to-be-trained convolutional neural network to obtain a first probability image of a class corresponding to a training object in the training region and a first probability image of a class of background in the training region. At last, a loss value is determined according to the first probability image of the class corresponding to the training object in the training region, the first probability image of the class of the background in the training region and the tag pattern of the sample image; and parameters of the to-be-trained convolutional neural network are updated according to the loss value. It is to be noted that there are not limits made on the loss function used when the loss value is determined in the embodiment of the disclosure.

In the embodiment of the disclosure, with the utilization of the edge points for guiding the convolutional neural network, the stability and generalization performance of the network are improved, and the timeliness and generalization performance of the algorithm are improved; the good segmentation effect may be obtained only with a small amount of training data; and an unseen segmentation object may be processed. In the related art, manners of clicking the foreground and background or drawing extreme points of the frames are used. Regardless of drawing dots, drawing lines or drawing frames, the efficiency is low, and it is hard to take the guidance effect, process irregular shapes and process unseen classes.

In the embodiment of the disclosure, with the utilization of the geodesic distance and the exponential transformation for encoding the edge points, not only can the region where the training object is located be highlighted obviously, but also the training of the convolutional neutral network can be guided without setting the parameters. The Euclidean distance, Gaussian distance and geodesic distance are used to encode the user interaction in the related art. Both the Euclidean distance and the Gaussian distance only give considerations to spatial distances of pixels and lack text information. The geodesic distance only takes the text information into account, but the scope of influence is too wide and the accurate guidance is taken difficultly.

### Application Example

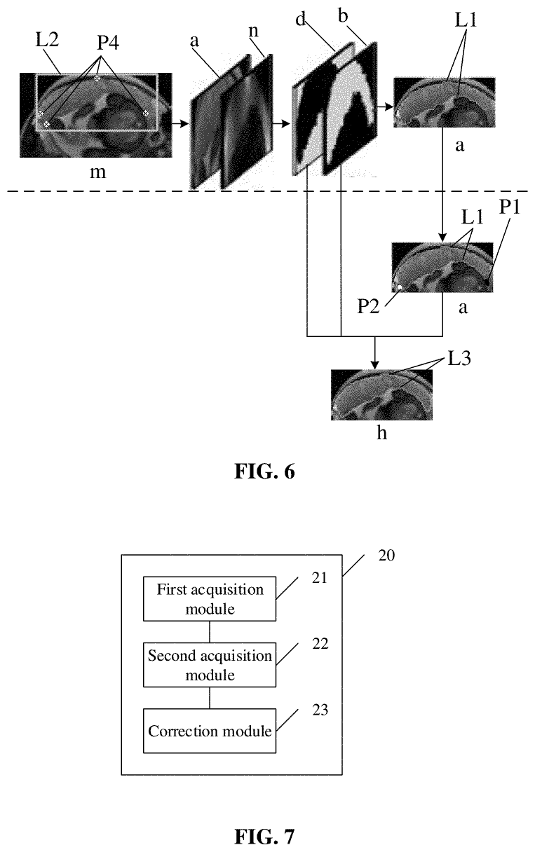

FIG. 6 illustrates an implementation flowchart of an image segmentation method according to an embodiment of the disclosure. As shown in FIG. 6, the case where the CT image of the spleen serves as the original image (m) and the spleen serves as the target object is used as an example. As shown in FIG. 6, the segmentation process includes two stages, in which the first stage is to acquire a first segmentation result, and the second stage is to correct the first segmentation result to obtain a second segmentation result.

In the first stage: the user adds four labeling points (P4) for the spleen class in the CT image, and executes the segmentation operation for the spleen in the CT image. Upon the reception of the segmentation operation, the four labeling points for the spleen may be acquired, a bounding box (L2) of the spleen is determined according to the four labeling points, and the CT image is clipped based on the bounding box of the spleen to obtain an unprocessed target image (a). An exponential transformation is performed on a geodesic distance of each pixel of the unprocessed target image (a) relative to the labeling points to obtain an encoded image (n) for the labeling points. The unprocessed target image (a) and the encoded image (n) for the labeling points are input to a convolutional neutral network to obtain a first probability image (b) of a foreground class (i.e., a spleen corresponding class) and a first probability class (d) of a background class. A first segmentation result of the target image (a) may be obtained according to the first probability image (b) of the foreground class and the first probability class (d) of the background class. In FIG. 6, the labeling line (L1) in the target image (a) is used to visually display the first segmentation result of the target image (a).

At this time, the first segmentation result includes the first probability image (b) of the foreground class and the first probability image (d) of the background class. When the first segmentation result of the target image is displayed visually, the user may view a region inside the labeling line L1 in the target image (a) as a region where the spleen in the CT image is located.

In the second stage: the user finds a wrongly segmented region in the target image (a), in which a part of pixels belonging to the spleen are wrongly segmented to the background class, and a part of pixels belonging to the background are wrongly segmented to the foreground class. The user may add a correction point (P1) of the foreground class to execute a correction operation on the foreground, and adds a correction point (P2) of the background class to execute a correction operation on the background. Upon the reception of the correction operations, both the foreground class and the background class may be determined as to-be-corrected classes, and the correction point of the foreground class and the correction point of the background class (i.e., P1 and P2) are respectively acquired. An exponential transformation is performed on a geodesic distance of each pixel of the target image (a) relative to the correction point (P1) of the foreground class to obtain the correction image (c) of the foreground class; and an exponential transformation is performed on a geodesic distance of each pixel of the target image (a) relative to the correction point (P2) of the foreground class to obtain the correction image (e) of the foreground class. The first probability image (b) of the foreground class is corrected according to the correction image (c) of the foreground class to obtain a second probability image (f) of the foreground class; and the first probability image (d) of the background class is corrected according to the correction image (e) of the background class to obtain a second probability image (g) of the background class. A second segmentation result of the target image (a) may be obtained according to the second probability image (f) of the foreground class and the second probability image (g) of the background class. In FIG. 6, the new labeling line (L3) in the final image (h) is used to visually display the second segmentation result of the target image (a). At this time, the second segmentation result includes the second probability image (f) of the foreground class and the second probability image (g) of the background class. When the second segmentation result of the target image is displayed visually, a region inside the new labeling line L3 in the final image (h) may be viewed as the region where the spleen in the CT image is located.

In the embodiment of the disclosure, when segmenting the lesion and/or organ (such as the spleen) from the medical image, the labeling staff only needs to add a few of labeling points to the medical image according to an outline of the lesion and/or organ to obtain the region where the lesion and/or organ is located, which helps the labeling staff reduce the labeling time and interaction; and thus, the medical image is segmented and labeled quickly and effectively. When finding the wrongly segmented region, the labeling staff only needs to add a few of correction points on the basis of the initial segmentation result to correct the segmentation result, thereby improving the accuracy of segmentation quickly and effectively. The intuitive and accurate segmentation result may help the doctor for diagnosis and treatment.

FIG. 7 illustrates a block diagram of an image segmentation apparatus according to an embodiment of the disclosure. As shown in FIG. 7, the apparatus 20 may include: a first acquisition module 21, configured to acquire a first segmentation result of a target image, the first segmentation result representing a probability that each pixel in the target image belongs to each class before correction; a second acquisition module 22, configured to acquire at least one correction point and a to-be-corrected class corresponding to the at least one correction point; and a correction module 23, configured to correct the first segmentation result according to the at least one correction point and the to-be-corrected class to obtain a second segmentation result.

In the embodiment of the disclosure, the correction point provided by the user may serve as priori knowledge to correct the wrongly segmented region in the initial segmentation result, thereby obtaining the corrected segmentation result; and with less user interaction, the effective and simple processing on the wrongly segmented region is implemented, and the timeliness and accuracy of image segmentation are improved.

In some embodiments, the first segmentation result includes multiple first probability images, each probability image corresponds to one class, the first probability image represents a probability that each pixel in the target image belongs to a class corresponding to the first probability image before correction, and the correction module 23 may include: a first determination module, configured to determine a correction image of the to-be-corrected class according to a similarity between each pixel of the target image and the correction point; an obtaining module, configured to correct a first probability image of the to-be-corrected class according to the correction image of the to-be-corrected class to obtain a second probability image of the to-be-corrected class, the second probability image of the to-be-corrected class representing a probability that each pixel in the target image belongs to the to-be-corrected class after correction; and a second determination module, configured to determine the second segmentation result of the target image according to the second probability image of the to-be-corrected class.

In some embodiments, the second determination module is further configured to: determine the second segmentation result of the target image according to the second probability image of the to-be-corrected class and a first probability image of an uncorrected class, the uncorrected class representing a class in classes corresponding to the multiple probability images except for the to-be-corrected class.

In some embodiments, the first determination module is further configured to perform an exponential transformation on a geodesic distance of each pixel of the target image relative to the correction point to obtain the correction image of the to-be-corrected class.

In some embodiments, the obtaining module is further configured to determine, for each pixel of the target image, in a case where a first value of the pixel is greater than a second value, the first value as a value at a position of the pixel in the second probability image of the to-be-corrected class to obtain the second probability image of the to-be-corrected class, the first value being a value at a position of the pixel in the correction image of the to-be-corrected class, and the second value being a value at a position of the pixel in the first probability image of the to-be-corrected class.

In some embodiments, the apparatus 20 may further include: a third acquisition module, configured to acquire, in a case where segmentation operation for a target object in an original image is received, multiple labeling points for the target object; a third determination module, configured to determine a bounding box of the target object according to the multiple labeling points; a clipping module, configured to clip the original image based on the bounding box of the target object to obtain the target image; a fourth acquisition module, configured to respectively acquire a first probability image of a class of background in the target image and a first probability image of a class corresponding to the target object in the target image; and a fourth determination module, configured to determine a first segmentation result of the target image according to the first probability image of the class corresponding to the target object in the target image and the first probability image of the class of the background in the target image.

In some embodiments, the first probability image of the target object corresponding class and the first probability image of the background class are acquired by a convolutional neural network, and the fourth acquisition module may include: a first obtaining submodule, configured to perform an exponential transformation on a geodesic distance of each pixel of the target image relative to the labeling points to obtain an encoded image for the labeling points; and a second obtaining submodule, configured to input the target image and the encoded image for the labeling points to the convolutional neural network to obtain the first probability image of the class corresponding to the target object and the first probability image of the class of the background.

In some embodiments, the apparatus 20 may further include: a training module, configured to train the convolutional neural network; and the training module may include: a generation submodule, configured to generate, in a case where a sample image is acquired, multiple edge points for a training object according to a tag pattern of the sample image, the tag pattern being configured to indicate a class to which each pixel in the sample image belongs; a first determination submodule, configured to determine a bounding box of the training object according to the multiple edge points; a clipping submodule, configured to clip the sample image according to the bounding box of the training object to obtain a training region; a transformation submodule, configured to perform an exponential transformation on a geodesic distance of each pixel of the training region relative to the edge points to obtain an encoded image for the edge points; a third obtaining submodule, configured to input the training region and the encoded image for the edge points to a to-be-trained convolutional neural network to obtain a first probability image of a class corresponding to a training object in the training region and a first probability image of a class of background in the training region; a second determination submodule, configured to determine a loss value according to the first probability image of the class corresponding to the training object in the training region, the first probability image of the class of the background in the training region and the tag pattern of the sample image; and an update submodule, configured to update parameters of the to-be-trained convolutional neural network according to the loss value.

In some embodiments, a region where the bounding box determined according to the multiple edge points is located covers a region where the training object in the sample image is located. In some embodiments, the target image includes a medical image, and each class includes a background and an organ and/or a lesion. In some embodiments, the medical image includes an MRI image and/or a CT image.

In some embodiments, the function or included module of the apparatus provided by the embodiment of the disclosure may be configured to execute the method described in the above method embodiments, and the specific implementation may refer to the description in the above method embodiments. For the simplicity, the details are not elaborated herein.

The embodiments of the disclosure further provide a computer-readable storage medium, in which a computer program instruction is stored, the computer program instruction being executed by a processor to implement the above method. The computer-readable storage medium may be a non-volatile computer-readable storage medium.

The embodiments of the disclosure further provide an electronic device, which may include: a processor; and a memory, configured to store an instruction executable for the processor; and the processor is configured to call the instruction stored in the memory to execute the above method.

The embodiments of the disclosure further provide a computer program product, which may include a computer-readable code; and when the computer-readable code runs in a device, a processor in the device executes an instruction to implement the image segmentation method provided by any of the above embodiments.

The embodiments of the application further provide another computer program product, configured to store a computer-readable instruction; and the instruction is executed to cause a computer to execute the image segmentation method provided by any of the above embodiments.

The electronic device may be provided as a terminal, a server or other types of devices.

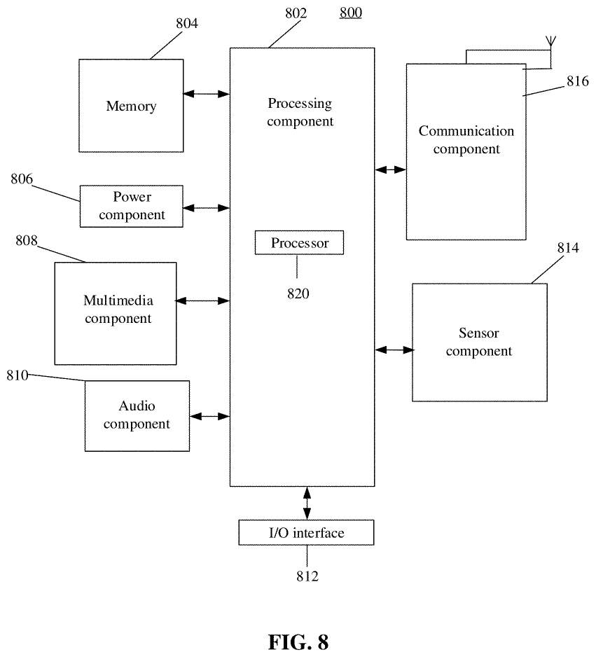

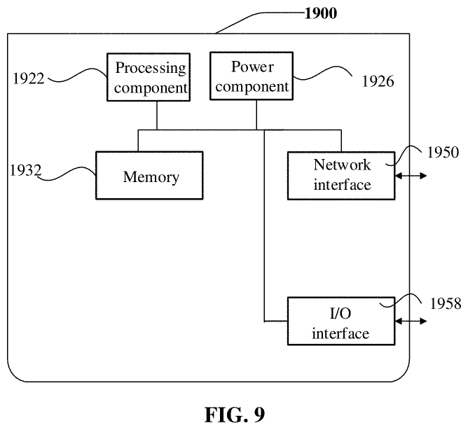

FIG. 8 illustrates a block diagram of an electronic device 800 according to an embodiment of the disclosure. For example, the electronic device 800 may be a terminal such as a mobile phone, a computer, a digital broadcast terminal, a messaging device, a gaming console, a tablet, a medical device, exercise equipment and a PDA.

Referring to FIG. 8, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any application or method operated on the electronic device 800, contact data, phonebook data, messages, pictures, videos, etc. The memory 804 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and any other components associated with the generation, management, and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may further be stored in the memory 804 or transmitted via the communication component 816. In some embodiments, the audio component 810 further includes a speaker configured to output audio signals.

The I/O interface 812 provides an interface between the processing component 802 and peripheral interface modules. The peripheral interface modules may be a keyboard, a click wheel, buttons, and the like. The buttons may include, but are not limited to, a home button, a volume button, a starting button, and a locking button.

The sensor component 814 includes one or more sensors to provide status assessments of various aspects of the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

Exemplarily, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, a non-volatile computer-readable storage medium, for example, a memory 804 including a computer program instruction, is also provided. The computer program instruction may be executed by a processing component 802 of an electronic device 800 to implement the abovementioned method. FIG. 9 illustrates a block diagram of an electronic device 1900 according to an embodiment of the disclosure. For example, the electronic device 1900 may be provided as a server. Referring to FIG. 9, the electronic device 1900 includes a processing component 1922, further including one or more processors, and a memory resource represented by a memory 1932, configured to store an instruction executable for the processing component 1922, for example, an application program. The application program stored in the memory 1932 may include one or more modules, with each module corresponding to one group of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS XTM, Unix™, Linux™, FreeBSD™ or the like.

In an exemplary embodiment, a non-volatile computer-readable storage medium, for example, a memory 1932 including a computer program instruction, is also provided. The computer program instruction may be executed by a processing component 1922 of an electronic device 1900 to implement the abovementioned method.

According to the image segmentation method and apparatus, the electronic device and the storage medium provided by the embodiments of the disclosure, the correction point provided by the user may serve as priori knowledge to correct the wrongly segmented region in the initial segmentation result, thereby obtaining the corrected segmentation result; and with less user interaction, the effective and simple processing on the wrongly segmented region is implemented, and the timeliness and accuracy of image segmentation are improved.

The present disclosure may be a system, a method and/or a computer program product. The computer program product may include a computer-readable storage medium, in which a computer-readable program instruction configured to enable a processor to implement each aspect of the present disclosure is stored

The computer-readable storage medium may be a physical device capable of retaining and storing an instruction used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the present disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit may execute the computer-readable program instruction to implement each aspect of the present disclosure.

Herein, each aspect of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the present disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

The computer program product may specifically be implemented through hardware, software or a combination thereof. In an optional embodiment, the computer program product is specifically embodied as a computer storage medium; and in another embodiment, the computer program product is specifically embodied as a software product, such as a Software Development Kit (SDK).

Each embodiment of the present disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the market best or enable others of ordinary skill in the art to understand each embodiment disclosed herein.

### INDUSTRIAL APPLICABILITY

In the embodiments, the electronic device gives considerations to the image segmentation on the target image to obtain the segmentation result in which the wrongly segmented region is corrected. Therefore, with less user interaction, the effective and simple processing on the wrongly segmented region is implemented, and the timeliness and accuracy of image segmentation are improved.

1. An image segmentation method, comprising:
acquiring a first segmentation result of a target image, the first segmentation result representing a probability that each pixel in the target image belongs to each class before correction;
acquiring at least one correction point and a to-be-corrected class corresponding to the at least one correction point; and
obtaining a second segmentation result by correcting the first segmentation result according to the at least one correction point and the to-be-corrected class.

2. The method of claim 1, wherein the first segmentation result comprises multiple first probability images, each first probability image corresponds to one class, the first probability image represents a probability that each pixel in the target image belongs to a class corresponding to the first probability image before correction, and obtaining the second segmentation result by correcting the first segmentation result according to the at least one correction point and the to-be-corrected class comprises:
determining a correction image of the to-be-corrected class according to a similarity between each pixel of the target image and the correction point;
obtaining a second probability image of the to-be-corrected class by correcting a first probability image of the to-be-corrected class according to the correction image of the to-be-corrected class, the second probability image of the to-be-corrected class representing a probability that each pixel in the target image belongs to the to-be-corrected class after correction; and
determining the second segmentation result of the target image according to the second probability image of the to-be-corrected class.

3. The method of claim 2, wherein determining the second segmentation result of the target image according to the second probability image of the to-be-corrected class comprises:
determining the second segmentation result of the target image according to the second probability image of the to-be-corrected class and a first probability image of an uncorrected class, the uncorrected class representing a class in classes corresponding to the multiple probability images except for the to-be-corrected class.

4. The method of claim 2, wherein determining the correction image of the to-be-corrected class according to the similarity between each pixel of the target image and the correction point comprises:
obtaining the correction image of the to-be-corrected class by performing an exponential transformation on a geodesic distance of each pixel of the target image relative to the correction point.

5. The method of claim 2, wherein obtaining the second probability image of the to-be-corrected class by correcting the first probability image of the to-be-corrected class according to the correction image of the to-be-corrected class comprises:
obtaining the second probability image of the to-be-corrected class by determining, for each pixel of the target image, in a case where a first value of the pixel is greater than a second value, the first value as a value at a position of the pixel in the second probability image of the to-be-corrected class, the first value being a value at a position of the pixel in the correction image of the to-be-corrected class, and the second value being a value at a position of the pixel in the first probability image of the to-be-corrected class.

6. The method of claim 1, further comprising:
acquiring, in a case where segmentation operation for a target object in an original image is received, multiple labeling points for the target object;
determining a bounding box of the target object according to the multiple labeling points;
obtaining the target image by clipping the original image based on the bounding box of the target object;
respectively acquiring a first probability image of a class of background in the target image and a first probability image of a class corresponding to the target object in the target image; and
determining the first segmentation result of the target image according to the first probability image of the class corresponding to the target object in the target image and the first probability image of the class of the background in the target image.

7. The method of claim 6, wherein the first probability image of the class corresponding to the target object and the first probability image of the class of the background are acquired by a convolutional neural network, and respectively acquiring the first probability images of the class corresponding to the target object in the target image and the class of the background in the target image comprises:
obtaining an encoded image for the labeling points by performing an exponential transformation on a geodesic distance of each pixel of the target image relative to the labeling points; and
obtaining the first probability image of the class corresponding to the target object and the first probability image of the class of the background by inputting the target image and the encoded image for the labeling points to the convolutional neural network.

8. The method of claim 7, wherein
training the convolutional neural network, comprising:
generating, in a case where a sample image is acquired, multiple edge points for a training object according to a tag pattern of the sample image, the tag pattern being configured to indicate a class to which each pixel in the sample image belongs;
determining a bounding box of the training object according to the multiple edge points;
obtaining a training region by clipping the sample image according to the bounding box of the training object;
obtaining an encoded image for the edge point by performing an exponential transformation on a geodesic distance of each pixel of the training region relative to the edge points;
obtaining a first probability image of a class corresponding to a training object in the training region and a first probability image of a class of background in the training region by inputting the training region and the encoded image for the edge points to a to-be-trained convolutional neural network;
determining a loss value according to the first probability image of the class corresponding to the training object in the training region, the first probability image of the class of the background in the training region and the tag pattern of the sample image; and
updating parameters of the to-be-trained convolutional neural network according to the loss value.

9. The method of claim 8, wherein a region where the bounding box determined according to the multiple edge points is located covers a region where the training object in the sample image is located.

10. The method of claim 1 wherein the target image comprises a medical image, and each class comprises a background and an organ and/or a lesion.

11. The method of claim 10, wherein the medical image comprises at least one of a Magnetic Resonance Imaging (MRI) image or a Computer Tomography (CT) image.

12. An image segmentation apparatus, comprising:
a processor; and
a memory, configured to store instructions executable for the processor, wherein
the processor is configured to call the instructions stored in the memory to:
acquire a first segmentation result of a target image, the first segmentation result representing a probability that each pixel in the target image belongs to each class before correction;
acquire at least one correction point and a to-be-corrected class corresponding to the at least one correction point; and
obtain a second segmentation result by correcting the first segmentation result according to the at least one correction point and the to-be-corrected class.

13. The apparatus of claim 12, wherein the processor is further configured to call the instructions stored in the memory to:
determine a correction image of the to-be-corrected class according to a similarity between each pixel of the target image and the correction point;
obtain a second probability image of the to-be-corrected class by correcting a first probability image of the to-be-corrected class according to the correction image of the to-be-corrected class, the second probability image of the to-be-corrected class representing a probability that each pixel in the target image belongs to the to-be-corrected class after correction; and
determine the second segmentation result of the target image according to the second probability image of the to-be-corrected class.

14. The apparatus of claim 13, wherein the processor is further configured to call the instructions stored in the memory to: determine the second segmentation result of the target image according to the second probability image of the to-be-corrected class and a first probability image of an uncorrected class, the uncorrected class representing a class in classes corresponding to the multiple probability images except for the to-be-corrected class.

15. The apparatus of claim 13, wherein the processor is further configured to call the instructions stored in the memory to: obtain the correction image of the to-be-corrected class by performing an exponential transformation on a geodesic distance of each pixel of the target image relative to the correction point.

16. The apparatus of claim 13, wherein the processor is further configured to call the instructions stored in the memory to: obtain the second probability image of the to-be-corrected class by determining, for each pixel of the target image, in a case where a first value of the pixel is greater than a second value, the first value as a value at a position of the pixel in the second probability image of the to-be-corrected class, the first value being a value at a position of the pixel in the correction image of the to-be-corrected class, and the second value being a value at a position of the pixel in the first probability image of the to-be-corrected class.

17. The apparatus of claim 12, wherein the processor is configured to call the instructions stored in the memory to:
acquire, in a case where segmentation operation for a target object in an original image is received, multiple labeling points for the target object;
determine a bounding box of the target object according to the multiple labeling points;
obtain the target image by clipping the original image based on the bounding box of the target object;
respectively acquire a first probability image of a class of background in the target image and a first probability image of a class corresponding to the target object in the target image; and
determine a first segmentation result of the target image according to the first probability image of the class corresponding to the target object in the target image and the first probability image of the class of the background in the target image.

18. The apparatus of claim 17, wherein the processor is configured to call the instructions stored in the memory to:
obtain an encoded image for the labeling points by performing an exponential transformation on a geodesic distance of each pixel of the target image relative to the labeling points; and
obtain the first probability image of the class corresponding to the target object and the first probability image of the class of the background by inputting the target image and the encoded image for the labeling points to a convolutional neural network.

19. The apparatus of claim 18, wherein the processor is configured to call the instructions stored in the memory to:
train the convolutional neural network; and
generate, in a case where a sample image is acquired, multiple edge points for a training object according to a tag pattern of the sample image, the tag pattern being configured to indicate a class to which each pixel in the sample image belongs;
determine a bounding box of the training object according to the multiple edge points;
obtain a training region by clipping the sample image according to the bounding box of the training object;
obtain an encoded image for the edge points by performing an exponential transformation on a geodesic distance of each pixel of the training region relative to the edge points;
obtain a first probability image of a class corresponding to a training object in the training region and a first probability image of a class of background in the training region by inputting the training region and the encoded image for the edge points to a to-be-trained convolutional neural network;
determine a loss value according to the first probability image of the class corresponding to the training object in the training region, the first probability image of the class of the background in the training region and the tag pattern of the sample image; and
update parameters of the to-be-trained convolutional neural network according to the loss value.

20. A non-transitory computer-readable storage medium having stored thereon computer program instructions that when executed by a processor, implement an image segmentation method, the method comprising:
acquiring a first segmentation result of a target image, the first segmentation result representing a probability that each pixel in the target image before correction belongs to each class;
acquiring at least one correction point and a to-be-corrected class corresponding to the at least one correction point; and
correcting the first segmentation result according to the at least one correction point and the to-be-corrected class to obtain a second segmentation result.
